(19) United States
(12) Patent Application Publication
(10) Pub. No.: US 2008/0289894 A1
(43) Pub. Date: Nov. 27, 2008

(54) Control Apparatus and Control Method for Vehicle

(75) Inventors: Koichiro Muta, Aichi-ken (JP); Katsuhiko Yamaguchi, Aichi-ken (JP); Eiji Masuda, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignees: Toyota Jidosha Kabushiki Kaisha, Toyota-shi, Aichi-ken (JP); Denso Corporation, Kariya-City, Aichi-Pref (JP)

(21) Appl. No.: 12/088,878

(22) PCT Filed: Feb. 6, 2007
(86) PCT No.: PCT/IB2007/000276

§ 371 Date: Apr. 1, 2008

(30) Foreign Application Priority Data
Feb. 8, 2006 (JP) 2006-031389

(51) Int. Cl. B60K 17/34

(52) U.S. Cl. 180/248

(57) ABSTRACT

A distribution ratio determining unit determines the distribution ratio for distributing a required torque based on a static load distribution ratio, when the sign of the required torque is negative. The distribution ratio determining unit determines the distribution ratio based on a dynamic load distribution ratio, when the sign of the required torque is positive. The distribution ratio determining unit determines the distribution ratio based on the static load distribution ratio and the dynamic load distribution ratio, when the sign of the required torque changes. Thus, even when the sign of the required torque changes, it is possible to prevent the driving forces for a plurality of wheels of a vehicle from changing discontinuously.

### BACKGROUND OF THE INVENTION

1. Field of the Invention

The invention relates generally to a control apparatus and a control method for a vehicle, and more specifically to a control apparatus and a control method for a vehicle including a plurality of power sources that drive a plurality of wheels.

2. Description of the Related Art

A vehicle including a plurality of power sources that drive a plurality of wheels, and a control apparatus for such a vehicle are generally known. For example, Japanese Patent Application Publication No. 2001-171378 (JP-A-2001-171378) describes a control apparatus for a four-wheel drive vehicle including a first prime mover adapted to drive one of front wheels and rear wheels and a second prime mover adapted to drive the other wheels.

The control apparatus calculates a target driving force based on a vehicle speed and a degree to which a driver has operated output operation means. The control apparatus controls a driving force for the front wheels and a driving force for the rear wheels so that the target driving force is output from the prime mover on the front-wheel side and the prime mover on the rear-wheel side, based on the condition of the vehicle and the operating state of the vehicle.

In such a four-wheel drive vehicle, the control apparatus determines a distribution ratio for distributing the target driving force to the front and rear wheels, based on the condition of the vehicle, the operating state of the vehicle, and the like. For example, when the vehicle is accelerating and therefore, the target driving force takes a positive value, the distribution ratio (dynamic load distribution ratio) is determined to be various values according to the condition under which the vehicle runs. In contrast, for example, when the vehicle is decelerating and therefore, the target driving force takes a negative value, the distribution ratio is determined to be equal to a static load distribution ratio (i.e., the ratio between a portion of a vehicle load that is applied to the front wheels and a portion of the vehicle load that is applied to the rear wheels when the vehicle is in a stopped state).

However, when the distribution ratio is determined in the above manner, if acceleration and deceleration of the vehicle are repeatedly performed, the distribution ratio may change discontinuously (change significantly) at the time of switching between acceleration and deceleration. Accordingly, there is a possibility of a sudden change in the driving forces for the front and rear wheels.

### SUMMARY OF THE INVENTION

The invention provides a control apparatus and a control method for a vehicle, which improve controllability of driving forces in a vehicle including a plurality of power sources that drive a plurality of wheels.

An aspect of the invention relates to a control apparatus for a vehicle including a plurality of power sources that drives a plurality of wheels. The control apparatus includes a required driving force determining unit and a distribution ratio determining unit. The required driving force determining unit determines a driving force required for the vehicle based on an operating state of the vehicle. The distribution ratio determining unit determines a distribution ratio for distributing the required driving force to the plurality of wheels, based on the operating state of the vehicle. The distribution ratio determining unit determines the distribution ratio based on a static load distribution ratio when the sign of the required driving force is negative. The distribution ratio determining unit determines the distribution ratio based on a dynamic load distribution ratio when the sign of the required driving force is positive. The distribution ratio determining unit determines the distribution ratio based on the static load distribution ratio and the dynamic load distribution ratio when the sign of the required driving force changes. The static load distribution ratio is a ratio between portions of a vehicle load that are applied to the plurality of wheels when the vehicle is in a stopped state, and the dynamic load distribution ratio is a ratio between portions of a vehicle load that are applied to the plurality of wheels when the vehicle is in a running state.

The plurality of drive power sources may include a first drive power source and a second drive power source. The first drive power source drives front wheels of the plurality of wheels. The second drive power source drives rear wheels of the plurality of wheels. At least one of the first drive power source and the second drive power source includes a motor.

When the sign of the required driving force changes, the distribution ratio determining unit may calculate the distribution ratio by linear interpolation between the dynamic load distribution ratio when the required driving force is 0 and the static load distribution ratio.

The static load distribution ratio may be a ratio between a portion of the vehicle load that is applied to the front wheels and a portion of the vehicle load that is applied to the rear wheels when the vehicle is in the stopped state, and the dynamic load distribution ratio may be a ratio between a portion of the vehicle load that is applied to the front wheels and a portion of the vehicle load that is applied to the rear wheels when the vehicle is in the running state.

According to the aspect of the invention, it is possible to improve controllability of driving forces in a vehicle including a plurality of power sources that drive a plurality of wheels.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram schematically showing the structure of a vehicle controlled by a vehicle control apparatus 90 according to an embodiment of the invention;

FIG. 2 is a control block diagram of the control apparatus 90 shown in FIG. 1;

FIG. 3 is a control block diagram showing an example of the structure of a rear wheel torque distribution ratio-calculating unit 92 shown in FIG. 2;

FIG. 4 is a flowchart explaining the processing performed by a control distribution ratio-determining unit 92B shown in FIG. 3;

FIG. 5 is a diagram explaining in detail the processing in Steps S2 and S3 shown in FIG. 4;

FIG. 6 is a diagram explaining a method of determining a rear wheel torque distribution ratio r according to the embodiment;

FIG. 7 is a diagram showing a simulation result of a change in rear wheel torque according to a comparative example of the embodiment; and

FIG. 8 is a diagram showing a simulation result of a change in rear wheel torque according to the embodiment.

### DETAILED DESCRIPTION OF THE PREFERRED EMBODIMENTS

Hereinafter, the embodiment of the invention will be described in detail with reference to the accompanying drawings. In the drawings, the same reference numerals denote the same or equivalent parts.

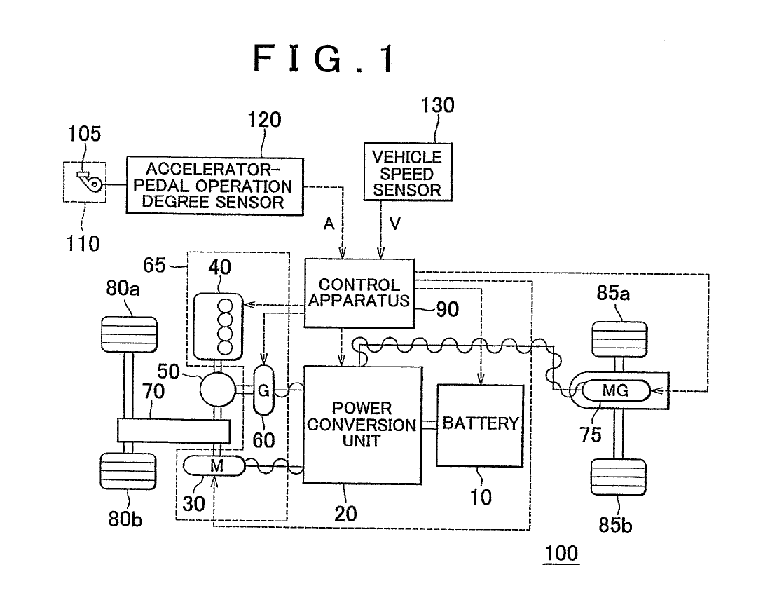

FIG. 1 is a block diagram schematically showing the structure of a vehicle controlled by a vehicle control apparatus according to an embodiment of the invention.

With reference to FIG. 1, a hybrid vehicle 100 includes a battery 10, a power conversion unit 20, a motor 30, an engine 40, a power split mechanism 50, a generator 60, a reducer 70, and front wheels 80a, 80b. Further, the hybrid vehicle 100 includes a motor generator 75 that serves as a motor and a generator, rear wheels 85a, 85b, and a control apparatus 90. Still further, the hybrid vehicle 100 includes an accelerator pedal device 110, an accelerator-pedal operation degree sensor 120, and a vehicle speed sensor 130.

The battery 10 is composed of a rechargeable secondary battery (for example, a nickel-hydrogen secondary battery, or a lithium-ion secondary battery). The power conversion unit 20 includes an inverter (not shown) that converts DC voltage supplied from the battery 10 to AC voltage for driving the motor 30 and the motor generator 75. The inverter is configured to convert DC power to AC power, and to convert AC power to DC power. Thus, the inverter also serves to convert the electric power (AC voltage) generated by the generator 60 and the electric power (AC voltage) generated by the motor 30 and the motor generator 75 when a regenerative brake is applied, to DC voltage for charging the battery 10.

The power conversion unit 20 may include a buck-boost converter (not shown) that changes the level of DC voltage. By providing such a buck-boost converter, it is possible to drive the motor 30 and the motor generator 75 using AC voltage with an amplitude of a higher voltage than the voltage supplied by the battery 10. Accordingly, it is possible to improve motor drive efficiency.

The engine 40 is an internal combustion engine using a fuel such as gasoline. The engine 40 outputs a driving force by converting thermal energy generated by combusting the fuel into kinetic energy. The power split mechanism 50 distributes the output from the engine 40 to a path through which the engine output is transmitted to the front wheels 80a, 80b via the reducer 70, and to a path through which the engine output is transmitted to the generator 60. The generator 60 is rotated by the output from the engine 40, which has been transmitted to the generator 60 via the power split mechanism 50, to generate electric power. The electric power generated by the generator 60 is used for charging the battery 10 or driving the motor 30 and the motor generator 75, by the power conversion unit 20.

The motor 30 is rotated and driven by the AC voltage supplied from the power conversion unit 20. The output from the motor 30 is transmitted to the front wheels 80a, 80b via the reducer 70. When a regenerative brake is applied, the motor 30 is rotated due to deceleration of the front wheels 80a, 80b so that the motor 30 serves as a generator.

The motor generator 75 is rotated and driven by the AC voltage supplied from the power conversion unit 20, as well as the motor 30. The output from the motor generator 75 is transmitted to the rear wheels 85a, 85b via a reducer (not shown). When a regenerative brake is applied, the motor generator 75 is rotated due to deceleration of the rear wheels 85a, 85b so that the motor generator 75 serves as a generator.

The accelerator pedal device 110 sets the accelerator-pedal operation degree in accordance with a force on an accelerator pedal 105 depressed by the driver. The accelerator-pedal operation degree sensor 120 is connected to the accelerator pedal device 110, and transmits to the control apparatus 90 an output voltage in accordance with an accelerator-pedal operation degree A.

The vehicle speed sensor 130 transmits to the control apparatus 90 an output voltage in accordance with a vehicle speed V of the hybrid vehicle 100.

When the hybrid vehicle 100 is started, or when the engine load is low, for example, when the hybrid vehicle 100 is running at a low speed or running down a gentle slope, the hybrid vehicle 100 runs using only the output from the motor 30 and the motor generator 75 without using the output from the engine 40, in order to avoid a situation where the hybrid vehicle 100 runs using the output from the engine 40 when engine efficiency is low. In this case, operation of the engine 40 is stopped unless warming-up is required. When warming-up is required, the engine 40 runs idle.

When the hybrid vehicle 100 is in a normal running state, the engine 40 is started and the output from the engine 40 is split by the power split mechanism 50 into a driving force for the front wheels 80a, 80b, and a driving force for the generator 60 that generates electric power. The electric power generated by the generator 60 is used for driving the motor 30. Accordingly, in the normal running state, the front wheels 80a, 80b are driven by the output from the engine 40 and the output from the motor 30 that assists the engine 40. The control apparatus 90 controls the ratio between the driving force for the front wheels 80a, 80b, and the driving force for the generator 60 to maximize the efficiency of the entire hybrid vehicle 100.

When the hybrid vehicle 100 is accelerating, the output from the engine 40 increases. The output from the engine 40 is split by the power split mechanism 50 into the driving force for the front wheels 80a, 80b, and the driving force for the generator 60 that generates electric power. The electric power generated by the generator 60 is used for driving the motor 30 and the motor generator 75. That is, when the hybrid vehicle 100 is accelerating, the front wheels 80a, 80b and the rear wheels 85a, 85b are driven by the driving force output from the engine 40 and the driving force output from the motor 30 and the motor generator 75.

When the hybrid vehicle 100 is decelerating or a brake is applied to the hybrid vehicle 100, the motor 30 is rotated by the front wheels 80a, 80b to generate electric power, while the motor generator 75 is rotated by the rear wheels 85a, 85b to generate electric power. The regenerative electric power generated by the motor 30 and the motor generator 75 is converted into DC power by the power conversion unit 20 to be used for charging the battery 10.

As described above, the hybrid vehicle 100 includes, as a plurality of power sources, the engine 40, the motor 30, the generator 60, and the motor generator 75. The plurality of power sources includes a power source 65 (a first power source), and the motor generator 75 (a second power source). The power source 65 (the first power source) is composed of the engine 40, the motor 30, and the generator 60. The power source 65 drives the two front wheels 80a, 80b of the plurality of wheels of the hybrid vehicle 100, while the motor generator 75 drives the two rear wheels 85a, 85b of the plurality of wheels.

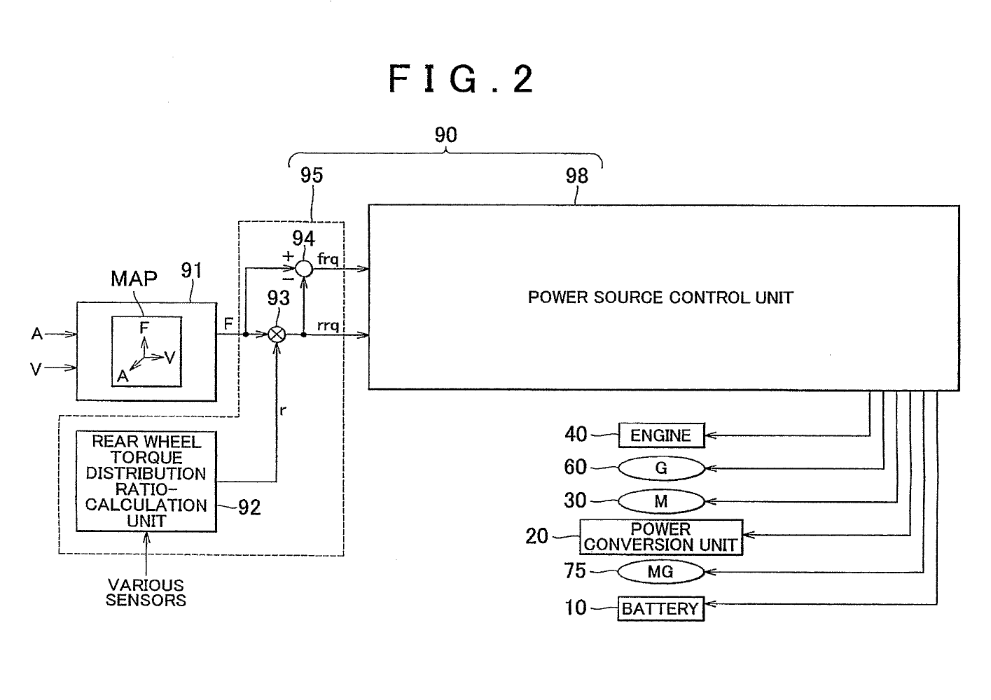

FIG. 2 is a control block diagram of the control apparatus 90 shown in FIG. 1. With reference to FIG. 2, the control apparatus 90 includes a required torque determining unit 91, a distribution ratio determining unit 95, and a power source control unit 98.

The required torque determining unit 91 determines a required driving force (required torque F) based on the operating state of the hybrid vehicle 100 in FIG. 1. The accelerator-pedal operation degree sensor 120 and the vehicle speed sensor 130 shown in FIG. 1 transmit to the required torque determining unit 91 information on the accelerator-pedal operation degree A and information on the vehicle speed V, respectively. The information on the accelerator-pedal operation degree A and the vehicle speed V is regarded as information relating to the “operating state” of the hybrid vehicle 100. The required torque determining unit 91 stores in advance a map indicative of the relationship among the accelerator-pedal operation degree A, the vehicle speed V, and the required torque F, and determines the required torque F by referring to the map.

The distribution ratio determining unit 95 determines, based on the operating state, the distribution ratio for distributing the required torque F to the front wheels and the rear wheels. Thus, according to the distribution ratio, the required torque F is divided into a front wheel required torque frq and a rear wheel required torque rrq.

The distribution ratio determining unit 95 includes a rear wheel torque distribution ratio-calculating unit 92, a multiplication unit 93, and an addition/subtraction unit 94.

The rear wheel torque distribution ratio-calculating unit 92 calculates a rear wheel torque distribution ratio r that achieves an ideal driving force distribution to the front wheels and the rear wheels, based on outputs from various sensors including the accelerator-pedal operation degree sensor 120 and the vehicle speed sensor 130 shown in FIG. 1, that is, based on the information relating to the “operating state” of the hybrid vehicle 100. Note that the rear wheel torque distribution ratio r takes a value between 0 and 1.

The multiplication unit 93 calculates the rear wheel required torque rrq by multiplying the required torque F by the rear wheel torque distribution ratio r (rrq=F×r). The addition/subtraction unit 94 calculates the front wheel required torque frq by subtracting the rear wheel required torque rrq from the required torque F (frq=F−rrq).

The distribution ratio determining unit 95 determines the distribution ratio for distributing the required torque F to the front wheels and the rear wheels, based on a static load distribution ratio when the required torque F takes a negative value. The distribution ratio determining unit 95 determines the distribution ratio based on a dynamic load distribution ratio when the required torque F takes a positive value. The distribution ratio determining unit 95 determines the distribution ratio using the static load distribution ratio and the dynamic load distribution ratio when the sign of the required torque F changes, that is, it changes from a positive value to a negative value, or a negative value to a positive value. Thus, even when the sign of the required torque F changes, it is possible to prevent the driving forces for the front and rear wheels of the hybrid vehicle 100 from changing discontinuously. That is, according to the embodiment, it is possible to improve controllability of driving forces in the hybrid vehicle 100.

It should be noted herein that, in the embodiment, the “dynamic load distribution ratio” means a ratio between a portion of a vehicle load that is applied to the front wheels and a portion of the vehicle load that is applied to the rear wheels when the vehicle is in a running state. The “static load distribution ratio” means a ratio between a portion of a vehicle load that is applied to the front wheels and a portion of the vehicle load that is applied to the rear wheels when the vehicle is in a stopped state. Also, in the embodiment, a rear static load distribution ratio r1 is a ratio of a portion of the vehicle load that is applied to the rear wheels to the entire vehicle load when the vehicle is in the stopped state. The rear static load distribution ratio r1 is set to a fixed value.

The positive sign of the required torque F indicates that the vehicle is, for example, started, accelerating, or running at a constant speed on a slope. The negative sign of the required torque F indicates that the vehicle is, for example, decelerating. The power source control unit 98 controls the plurality of power sources, i.e., the engine 40, the motor 30, the generator 60, the motor generator 75, the battery 10, and the power conversion unit 20, according to the above-mentioned distribution ratio. Thus, the front wheels are driven by the front wheel required torque frq, and the rear wheels are driven by the rear wheel required torque rrq.

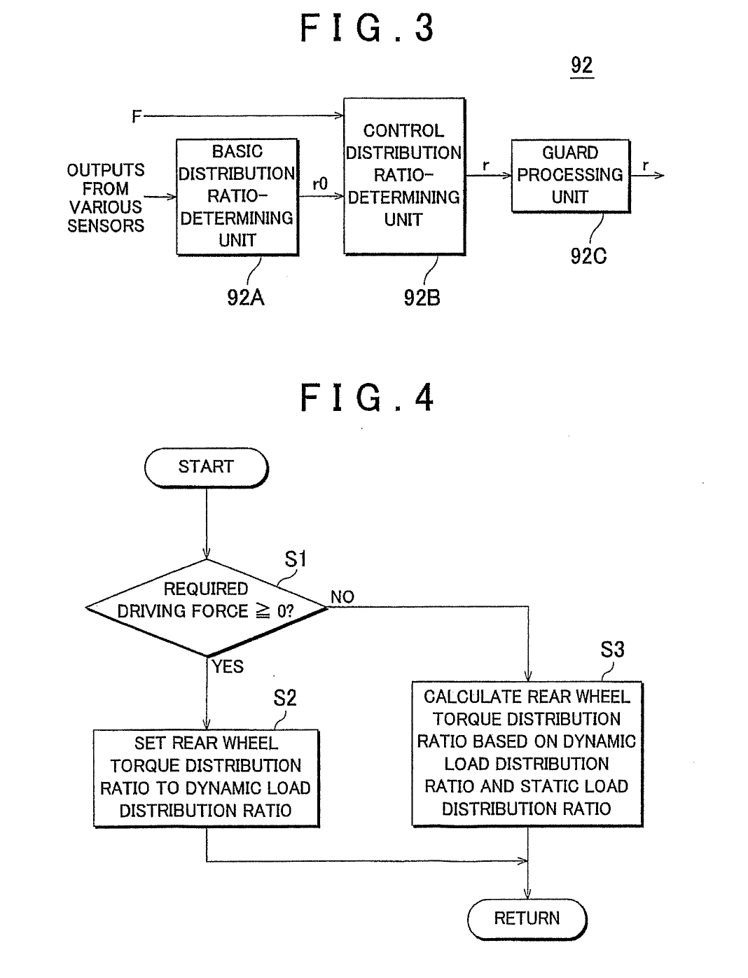

FIG. 3 is a control block diagram showing an example of the structure of the rear wheel torque distribution ratio-calculating unit 92 shown in FIG. 2.

With reference to FIG. 3, the rear wheel torque distribution ratio-calculating unit 92 includes a basic distribution ratio-determining unit 92A, a control distribution ratio-determining unit 92B, and a guard processing unit 92C.

The basic distribution ratio-determining unit 92A transmits the value of a rear dynamic load distribution ratio r0 to the control distribution ratio-determining unit 92B when the hybrid vehicle 100 shown in FIG. 1 is accelerating. The value of the rear dynamic load distribution ratio r0 is determined based on outputs from various sensors.

The control distribution ratio-determining unit 92B determines the value of the rear wheel torque distribution ratio r based on the required torque F. The processing performed by the control distribution ratio-determining unit 92B will be described in detail later.

When the value of the rear wheel torque distribution ratio r exceeds an upper limit value, the guard processing unit 92C sets the value of % the rear wheel torque distribution ratio r to the upper limit value. When the value of the rear wheel torque distribution ratio r is less than a lower limit value, the guard processing unit 92C sets the value of the rear wheel torque distribution ratio r to the lower limit value. In this manner, the range of the rear wheel torque distribution ratio r is limited. Accordingly, for example, when the hybrid vehicle 100 is turned on a road surface with an extremely low friction coefficient, it is possible to prevent the hybrid vehicle 100 from slipping.

FIG. 4 is a flowchart explaining the processing performed by the control distribution ratio-determining unit 92B shown in FIG. 3.

With reference to FIG. 4 and FIG. 3, when the processing is started, the control distribution ratio-determining unit 92B determines in step S1 whether the required driving force (required torque F) is equal to or more than 0. When the required driving force is equal to or more than 0 (YES in step S1), the control distribution ratio-determining unit 92B sets, in step S2, the rear wheel torque distribution ratio r to the value of the rear dynamic load distribution ratio r0. That is, the control distribution ratio-determining unit 92B outputs the value of the rear dynamic load distribution ratio r0 received from the basic distribution ratio-determining unit 92A, as it is.

When the required driving force (required torque F) is less than 0 (NO in step S1), the control distribution ratio-determining unit 92B calculates, in step S3, the rear wheel torque distribution ratio r based on the rear dynamic load distribution ratio r0 and the rear static load distribution ratio r1. Note that the control distribution ratio-determining unit 92B holds the value of the rear static load distribution ratio r1 in advance. When the processing in step S2 or S3 is completed, the processing returns to step S1.

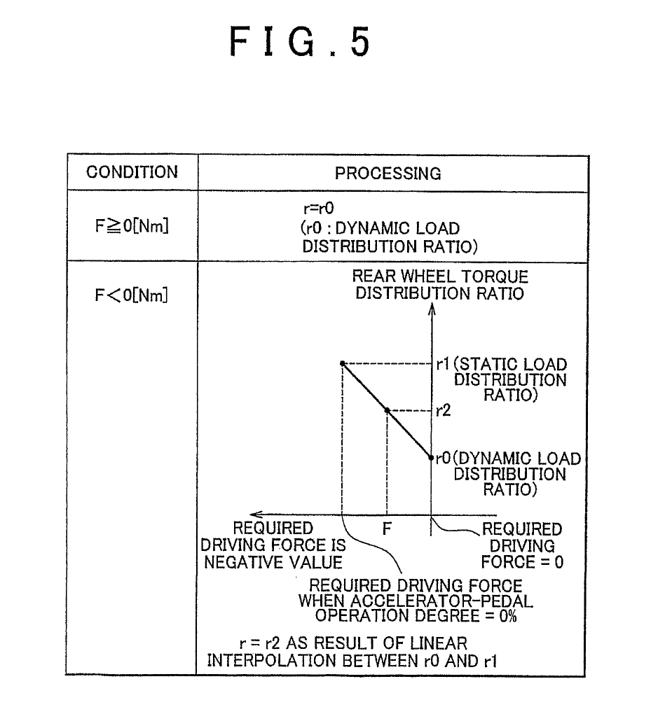

FIG. 5 is a diagram explaining in detail the processing in Steps S2 and S3 shown in FIG. 4.

With reference to FIG. 5, when the required torque F is equal to or more than 0 (F≧0 [Nm]), the processing shown in step S2 of FIG. 4 is executed. That is, the control distribution ratio-determining unit 92B sets the rear wheel torque distribution ratio r to the rear dynamic load distribution ratio r0.

When the required torque F is less than 0 (F<0 [Nm]), the processing shown in step S3 of FIG. 4 is executed. The control distribution ratio-determining unit 92B calculates the rear wheel torque distribution ratio r that corresponds to a certain required torque F, by linear interpolation between the rear dynamic load distribution ratio r0 when the required driving force (required torque F) is 0 and the rear static load distribution ratio r1 corresponding to the required driving force when the accelerator-pedal operation degree is 0%. In this case, the rear wheel torque distribution ratio r is r2.

According to related art, when the sign of the required torque F changes, the rear wheel torque distribution ratio r switches between r0 and r1. In the embodiment, when the required torque F changes from a positive value to a negative value, the rear wheel torque distribution ratio r changes in the order of r0, r2, and r1. Further, in the embodiment, when the required torque changes from a negative value to a positive value, the rear wheel torque distribution ratio r changes in the order of r1, r2, and r0.

In this manner, according to the embodiment, it is possible to prevent the rear wheel torque distribution ratio r from changing discontinuously (changing significantly). In other words, according to the embodiment, when the required torque F switches between a positive value and a negative value, it is possible to prevent a sudden change in driving forces for the front and rear wheels.

In addition, according to the embodiment, it is possible to prevent regenerative electric power generated by the motor 30 and the motor generator 75 shown in FIG. 1 from changing abruptly. This is because the driving forces for the front and rear wheels can be prevented from changing abruptly when the required torque F switches between a positive value and a negative value.

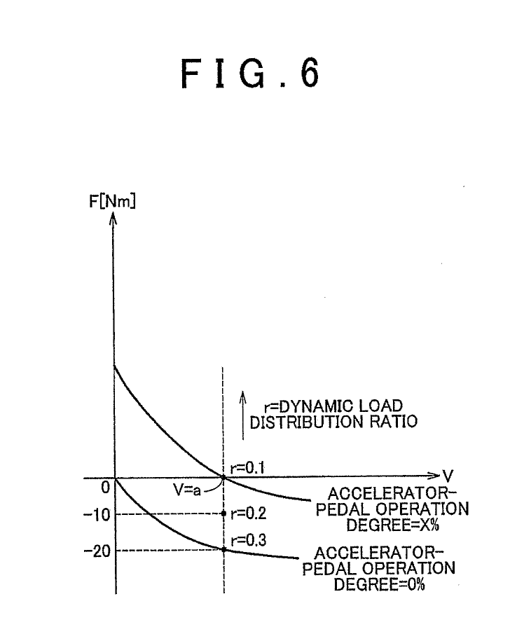

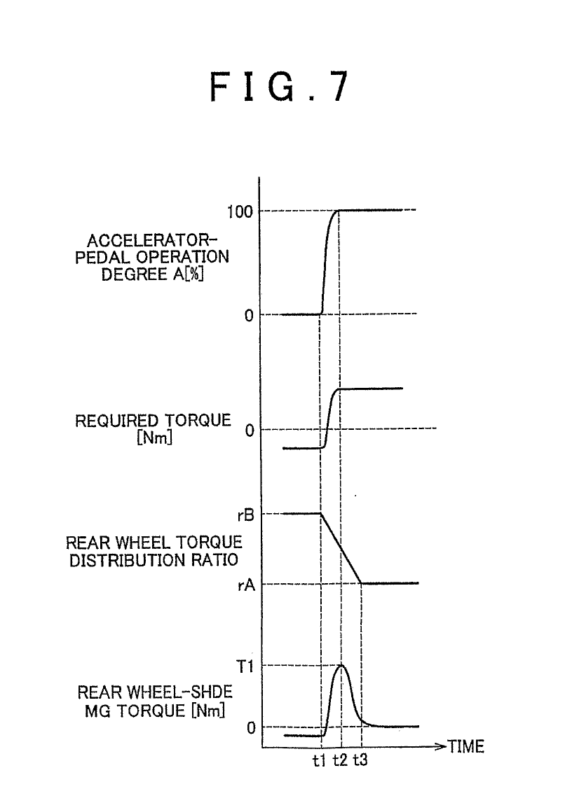

FIG. 6 is a diagram explaining a method of determining the rear wheel torque distribution ratio r according to the embodiment. The values shown in FIG. 6 are mere examples for facilitating understanding of the invention, and the invention is not limited by these values.

With reference to FIG. 6, when the vehicle speed V is equal to “a” and the accelerator-pedal operation degree A is equal to X % (0≦X≦100), the required torque F is equal to 0. At this time, the rear wheel torque distribution ratio r (i.e., the rear dynamic load distribution ratio) is 0.1. It is predetermined that the required torque F is −20 [Nm] and the rear wheel torque distribution ratio r (i.e., the rear static load distribution ratio) is 0.3 when the vehicle speed V is equal to “a” and the accelerator-pedal operation degree A is equal to 0%.

Accordingly, when the vehicle speed V is equal to “a” and the accelerator-pedal operation degree A is equal to a value between 0 and X (0<A<X), if the required torque F is determined to be −10 [Nm], the rear wheel torque distribution ratio r is calculated to be an intermediate value between 0.1 and 0.3, that is, 0.2.

Next, effects of the invention will be described more specifically. FIG. 7 is a diagram showing a simulation result of a change in rear wheel torque according to a comparative example of the embodiment.

With reference to FIG. 7, the accelerator-pedal operation degree A starts to change from 0% at a time t1, and reaches 100% at a time t2. The required torque changes from a negative value to a positive value in accordance with a change in the accelerator-pedal operation degree A.

The rear torque distribution ratio r is equal to a rear static load distribution ratio rB at the time t1. In this comparative example, when the sign of the required torque changes, the rear wheel torque distribution ratio r is reduced by a constant value per unit time. The rear wheel torque distribution ratio r reaches a rear dynamic load distribution ratio rA at a time t3. Because the rear torque distribution ratio r is reduced at a constant rate, the time t3 is determined, regardless of the time t2.

Here, it is assumed that the rear dynamic load distribution ratio rA is equal to 0 (rA=0). That is, it is assumed that the motor 30 and the motor generator 75 generate regenerative electric power in the hybrid vehicle 100 shown in FIG. 1 before the time t1, and the hybrid vehicle 100 runs with the front wheels driven by the front engine (hereinafter, such a running state is referred to as “FF running”) after the time t1. During the FF running, it is possible to improve fuel economy of the hybrid vehicle 100, if the torque of the motor generator 75 is set to 0.

The torque of the rear wheel-side MG (i.e., the motor generator 75 shown in FIG. 1) takes a negative value before the time t1. Because the required torque changes from a negative value to a positive value between the time t1 and the time t2, the torque of the rear wheel-side MG also changes from a negative value to a positive value. Thus, the torque of the rear wheel-side MG reaches T1 (T1>0) at the time t2. After the time t2, the required torque takes a positive constant value, however, the rear wheel torque distribution ratio r decreases. Therefore, the torque of the rear wheel-side MG also decreases. Finally, the torque of the rear wheel-side MG becomes equal to 0 at the time t3.

It is preferable that the torque of the rear wheel-side MG reaches 0 in the shortest period of time as possible, after the time t1. However, in the comparative example, the torque of the rear wheel-side MG becomes 0 after it changes to a positive value temporarily. In other words, the torque of the rear wheel-side MG changes significantly between the time t1 and the time t2, and between the time t2 and the time t3. In addition, there is a time period during which the torque of the rear wheel-side MG takes a positive value. Therefore, the FF running is not performed in this period.

These problems are caused because the rear wheel torque distribution ratio r is reduced by a constant value per unit time. As the time period during which the accelerator-pedal operation degree changes from 0% to 100% becomes shorter, such problems are more likely to occur in the comparative example.

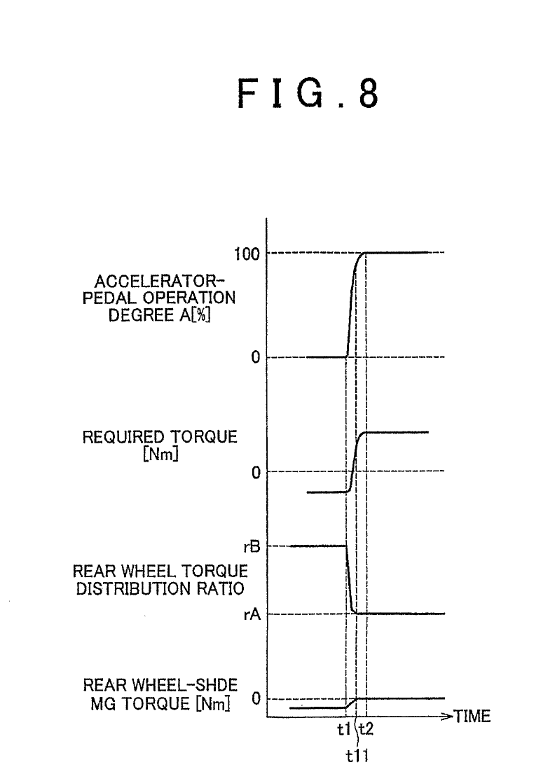

FIG. 8 is a diagram showing a simulation result of a change in rear wheel torque according to the embodiment. Note that the respective times t1, t2 shown in FIG. 8 are the same as those in FIG. 7, for convenience of comparison with FIG. 7.

With reference to FIG. 8, the accelerator-pedal operation degree A changes in the same manner as in FIG. 7. During the period of time from the time t1 to a time t11, the required torque changes from a negative value to a positive value. During the period of time when the required torque takes a negative value, the rear wheel torque distribution ratio r is determined by linear interpolation between the rear dynamic load distribution ratio when the required torque is 0 and the rear static load distribution ratio rB.

In accordance with the change of the required torque from a negative value to a positive value, the rear wheel torque distribution ratio r becomes equal to the rear dynamic load distribution ratio rA (i.e., 0) at the time t11. That is, it is determined that the required torque is equal to or more than 0 for the first time at the time t11, after it is determined that the required torque (required driving force) is a negative value in step S1 in the flowchart shown in FIG. 4. The torque of the rear wheel-side MG is a negative value at the time t1, and it gradually increases after the time t1 to reach 0 at the time t11. Note that the time t11 is an earlier time than the time t2.

As can be seen from the comparison between FIG. 7 and FIG. 8, according to the embodiment, the torque of the rear wheel-side MG exhibits a smaller change. Also as can be seen from FIG. 7 and FIG. 8, according to the embodiment, it is possible to switch the operating state of the hybrid vehicle 100 from the regenerative power generation state to the FF running state, in a shorter period of time.

As described so far, according to the embodiment, in a vehicle including a plurality of power sources that drive a plurality of wheels, the distribution ratio determining unit distributes the required torque to the plurality of wheels, based on the distribution ratio calculated based on the static load distribution ratio and the dynamic load distribution ratio when the sign of the required driving force changes. Thus, it is possible to prevent a sudden change in the driving forces for the front and rear wheels when the sign of the required driving force changes.

In addition, according to the embodiment, at least one of the front wheels and the rear wheels are driven by the motor, it is possible to prevent a sudden change in the regenerative electric power generated by the motor.

It should be noted herein that, in the above description, the plurality of power sources includes the first power source for driving the two front wheels and the second power source for driving the two rear wheels. However, the invention is also applicable to a vehicle having a structure in which a plurality of power sources (for example, four power sources) are provided to respectively drive a plurality of wheels (for example, four wheels).

The embodiment disclosed herein is merely exemplary, and is in no way intended to limit the invention. The scope of the invention is not defined by the above description but by the claims, and all changes which come within the meaning and range of equivalency of the claims are intended to be embraced therein.

1. A control apparatus for a vehicle including a plurality of power sources that drives a plurality of wheels, comprising:
a required driving force determining unit that determines a driving force required for the vehicle based on an operating state of the vehicle;
a distribution ratio determining unit that determines a distribution ratio for distributing the required driving force to the plurality of wheels, based on the operating state of the vehicle;
a power source control unit that controls the plurality of power sources in accordance with the distribution ratio,
wherein the distribution ratio determining unit determines the distribution ratio, based on a static load distribution ratio when a sign of the required driving force is negative, based on a dynamic load distribution ratio when the sign of the required driving force is positive, and based on the static load distribution ratio and the dynamic load distribution ratio when the sign of the required driving force changes; and
wherein the static load distribution ratio is a ratio between portions of a vehicle load that are applied to the plurality of wheels when the vehicle is in a stopped state, and the dynamic load distribution ratio is a ratio between portions of a vehicle load that are applied to the plurality of wheels when the vehicle is in a running state.

2. The control apparatus according to claim 1, wherein
the plurality of drive power sources includes a first drive power source that drives front wheels of the plurality of wheels and a second drive power source that drives rear wheels of the plurality of wheels, and
at least one of the first drive power source and the second drive power source includes a motor.

3. The control apparatus according to claim 1, wherein
when the sign of the required driving force changes, the distribution ratio determining unit calculates the distribution ratio by linear interpolation between the dynamic load distribution ratio when the required driving force is 0 and the static load distribution ratio.

4. The control apparatus according to claim 1, wherein
the static load distribution ratio is a ratio between a portion of the vehicle load that is applied to the front wheels and a portion of the vehicle load that is applied to the rear wheels when the vehicle is in the stopped state, and the dynamic load distribution ratio is a ratio between a portion of the vehicle load that is applied to the front wheels and a portion of the vehicle load that is applied to the rear wheels when the vehicle is in the running state.

5. The control apparatus according to claim 1, wherein
the distribution ratio determining unit continuously changes the distribution ratio when the sign of the required driving force changes.

6. A control method for a vehicle including a plurality of power sources that drives a plurality of wheels, comprising:
determining a driving force required for the vehicle based on an operating state of the vehicle;
determining a distribution ratio for distributing the required driving force to the plurality of wheels, based on a static load distribution ratio when a sign of the required driving force is negative, based on a dynamic load distribution ratio when the sign of the required driving force is positive, and based on the static load distribution ratio and the dynamic load distribution ratio when the sign of the required driving force changes, wherein the static load distribution ratio is a ratio between portions of a vehicle load that are applied to the plurality of wheels when the vehicle is in a stopped state, and the dynamic load distribution ratio is a ratio between portions of a vehicle load that are applied to the plurality of wheels when the vehicle is in a running state; and
controlling the plurality of power sources in accordance with the determined distribution ratio.

7. The control apparatus according to claim 2, wherein
when the sign of the required driving force changes, the distribution ratio determining unit calculates the distribution ratio by linear interpolation between the dynamic load distribution ratio when the required driving force is 0 and the static load distribution ratio.
